(19) United States
(12) Patent Application Publication
(10) Pub. No.: US 2026/0326554 A1
(43) Pub. Date: Oct. 22, 2026

(54) DISPLAY DEVICE FOR VEHICLE

(71) Applicant: YAZAKI CORPORATION, Tokyo (JP)

(72) Inventor: Tomohiro Miyazawa, Susono-shi (JP)

(21) Appl. No.: 19/651,647

(22) Filed: Apr. 18, 2026

(30) Foreign Application Priority Data
Apr. 21, 2025 (JP) 2025-069632
Nov. 12, 2025 (JP) 2025-192686

(51) Int. Cl. B60K 35/232; B60K 35/233; B60K 35/234

(52) U.S. Cl. CPC B60K 35/232; B60K 35/233; B60K 35/234

(57) ABSTRACT

A vehicle display device is installed in a vehicle and presents visible information emitted from an indicator to a driver by reflecting the visible information on a windshield. The indicator emits the visible information such that the visible information to be emitted satisfies formulas (1) and (2) in which a display distance is X [m] and a horizontal width of the visible information is Y [°]:

Y≥−0.3X+3.6 (1);

4≤X≤6 (2).

### CROSS-REFERENCE TO RELATED APPLICATIONS

This application is based on and claims priority under 35 USC 119 from Japanese Patent Application No. 2025-069632 filed on Apr. 21, 2025 and Japanese Patent Application No. 2025-192686 filed on Nov. 12, 2025, the entire content of which is incorporated herein by reference.

### TECHNICAL FIELD

The present disclosure relates to a vehicle display device.

### BACKGROUND ART

There is known an augmented reality head-up display (AR-HUD) that displays various types of information (road information, navigation information, and the like) necessary for driving by a driver on a windshield of a vehicle by superimposing the information on a scene actually seen by the driver.

When the driver looks at a vehicle or the like ahead, a gaze point of the driver is not present at a closest distance such as a meter on a dashboard. Accordingly, when the AR-HUD displays information at a closest distance, the driver may see the information as a double image due to binocular disparity.

In JP2007-008382A, visible information having a prescribed length in a horizontal direction is repeatedly displayed in the horizontal direction and positions of the visible information seen by left and right eyes due to binocular disparity overlap under a prescribed condition, so that a driver can see one piece of visible information. However, a horizontal width of the visible information is limited, and it cannot be said that discomfort felt by the driver is sufficiently reduced.

The present disclosure provides a vehicle display device that can relieve annoyance and discomfort caused by a double image due to binocular disparity.

### SUMMARY OF INVENTION

To achieve the above object, the vehicle display device according to the present disclosure has following features. A vehicle display device is installed in a vehicle and presents visible information emitted from an indicator to a driver by reflecting the visible information on a windshield. The indicator emits the visible information such that the visible information to be emitted satisfies formulas (1) and (2) in which a display distance is X [m] and a horizontal width of the visible information is Y [°].

Y≥−0.3X+3.6 (1)

4≤X≤6 (2)

According to the present disclosure, even when visible information is presented in a state in which a driver is looking ahead of a vehicle such as a preceding vehicle, the information can be presented without causing the driver to feel annoyed or uncomfortable due to a double image caused by binocular disparity.

The present disclosure is briefly described above. Further, details of the present disclosure can be clarified by reading modes (hereinafter, referred to as “embodiments”) for carrying out the disclosure to be described below with reference to accompanying drawings.

### BRIEF DESCRIPTION OF DRAWINGS

FIG. 1 is a block diagram of a vehicle display system including a vehicle display device according to a first embodiment of the present disclosure;

FIG. 2 is a schematic diagram showing a situation in which an indicator displays visible information at a prescribed display distance;

FIG. 3 shows a relationship of visible information, gaze point, and binocular disparity viewed from a driver;

FIG. 4 is a schematic diagram of visible information displayed by the vehicle display device according to the first embodiment;

FIG. 5 shows a relationship between a horizontal width of visible information and a sensory evaluation value related to an appearance of the visible information when a display distance is 2 m in a sensory test;

FIG. 6 shows a relationship between the horizontal width of visible information and the sensory evaluation value related to the appearance of the visible information when the display distance is 4 m in the sensory test;

FIG. 7 shows a relationship between the horizontal width of visible information and the sensory evaluation value related to the appearance of the visible information when the display distance is 6 m in the sensory test;

FIG. 8 shows a relationship between the horizontal width of visible information and the sensory evaluation value related to the appearance of the visible information when the display distance is 8 m in the sensory test;

FIG. 9 shows results of the sensory test;

FIG. 10 shows a relationship between a display distance and a horizontal width of visible information for displaying visible information that does not cause annoyance, which is derived from the results of the sensory test;

FIG. 11 shows a luminance distribution of visible information when a distance from a preceding vehicle is long;

FIG. 12 shows a luminance distribution of visible information when the distance from the preceding vehicle is short;

FIG. 13 shows a relationship between movement of visible information and a sensory evaluation value related to an appearance of the visible information in a second sensory test regarding visible information displayed by a vehicle display device according to a second embodiment;

FIG. 14 is a schematic diagram showing movement of visible information displayed by the vehicle display device according to the second embodiment;

FIGS. 15A to 15C show movement of visible information displayed by the vehicle display device according to the second embodiment at a time of turning right or left, in which FIG. 15A shows movement at a point far from a right or left turn point, FIG. 15B shows movement at a point close to the right or left turn point, and FIG. 15C shows movement at a point closest to the right or left turn point;

FIG. 16 is a schematic diagram of visible information displayed by a vehicle display device according to a third embodiment; and

FIG. 17 shows a relationship between presentation time of visible information and a ratio of persons feeling annoyed.

### DESCRIPTION OF EMBODIMENTS

Specific embodiments of the present disclosure will be described below with reference to drawings.

### First Embodiment

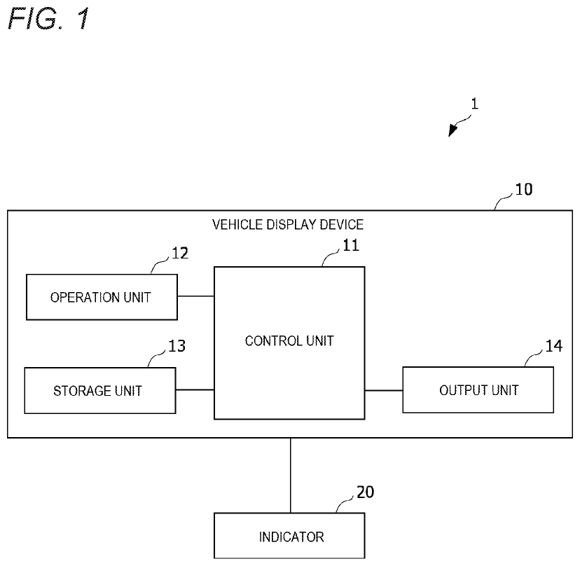

FIG. 1 is a block diagram of a vehicle display system including a vehicle display device according to a first embodiment of the present disclosure. A vehicle display system 1, which is installed in a vehicle, includes a vehicle display device 10 and an indicator 20 and corresponds to a so-called AR-HUD.

The vehicle display device 10 includes a control unit 11, an operation unit 12, a storage unit 13, and an output unit 14. The control unit 11 is a so-called arithmetic processing device or processor, and is a computer that controls the entire vehicle display device 10. The operation unit 12 is a switch, a button, a touch panel, or the like for a driver or the like of the vehicle to perform input for operating the vehicle display device 10. The storage unit 13 stores various programs, data, and the like. By reading, for example, the programs stored in the storage unit 13, the control unit 11 executes various processes by the vehicle display device 10, including processes in embodiments to be described below. The output unit 14 outputs, for example, an image generated by the control unit 11 to the indicator 20.

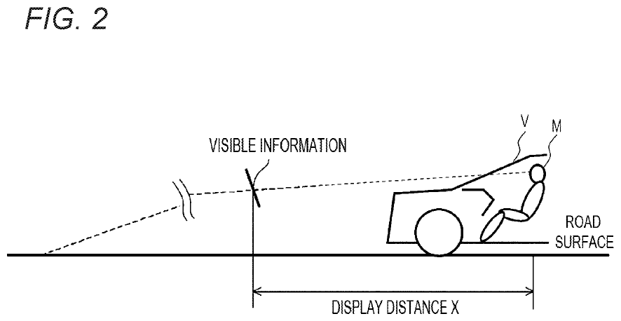

The indicator 20 includes a head-up display, a projector, or the like that outputs the image output from the output unit 14. FIG. 2 is a schematic diagram showing a situation in which the indicator 20 displays visible information, which is a type of an output image, at a prescribed display distance X [m]. The indicator 20 emits visible information such that the visible information appears at a prescribed virtual display distance from a gaze point of a driver M of a vehicle V. The visible information is reflected by a windshield of the vehicle V and presented at the prescribed display distance.

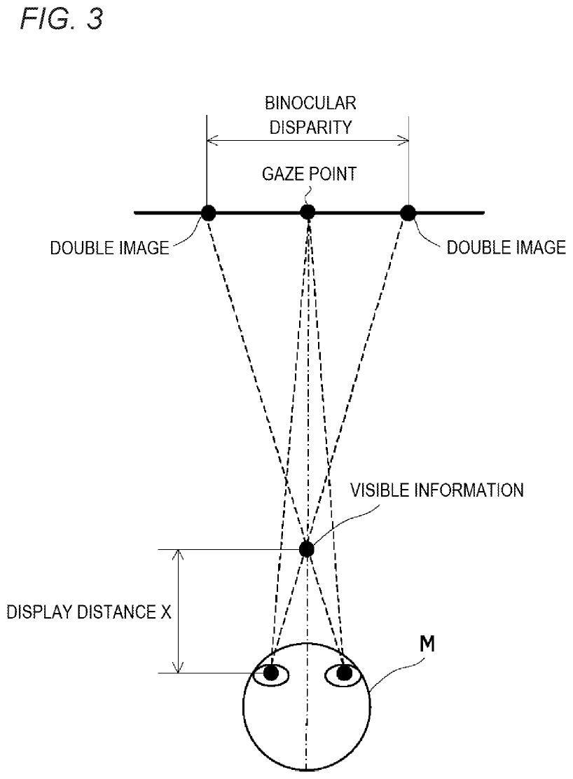

FIG. 3 shows a relationship of visible information, gaze point, and binocular disparity viewed from the driver M. The driver M drives while looking at a scene ahead, and the gaze point of the driver M is in a range of tens to hundreds of meters ahead. On the other hand, a vehicle display device in the related art may display visible information a few meters ahead from the gaze point of the driver M. In this case, due to a distance difference between the gaze point and the visible information, as well as binocular disparity of the driver M, the visible information appears as a double image when viewed from the driver M, and the driver M feels annoyed or uncomfortable.

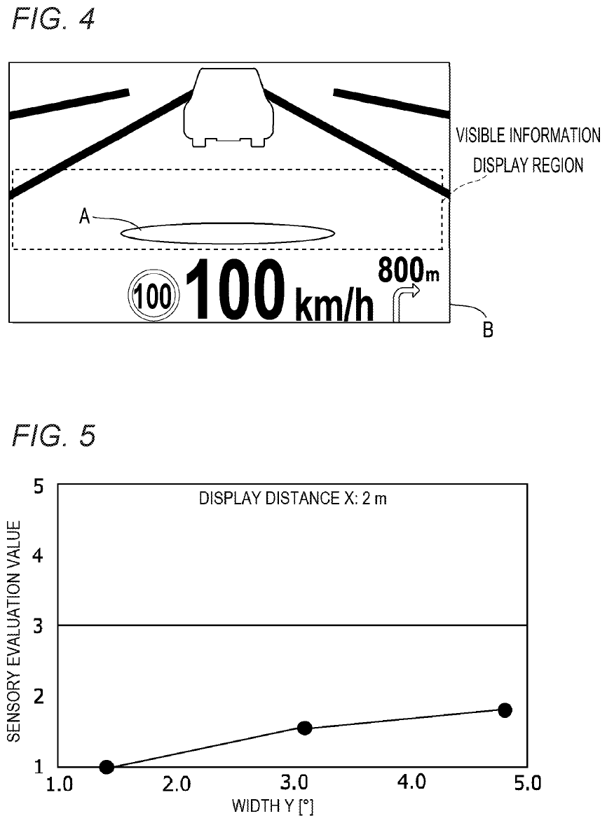

FIG. 4 is a schematic diagram of visible information displayed by the vehicle display device 10 according to the first embodiment. The visible information is, for example, a spot A displayed to follow a preceding vehicle by adaptive cruise control (ACC). Information such as the spot A is generally presented meters close. In a device in the related art, when the driver M drives while looking at a scene ahead such as a distant vehicle ahead, the spot A may be seen as a double image and the driver M may feel annoyed or uncomfortable.

On the other hand, in the vehicle display device 10 according to the present embodiment, the indicator 20 emits visible information to a specific visible information emission region, so that the driver M feels less annoyed or uncomfortable, and the problem of the device in the related art is solved. The vehicle display device 10 may also display other information (speed, navigation information, and the like) B as in the related art, however, when looking at such information, the driver M usually moves the gaze point nearby to check the information, and the problem of a double image is less likely to occur.

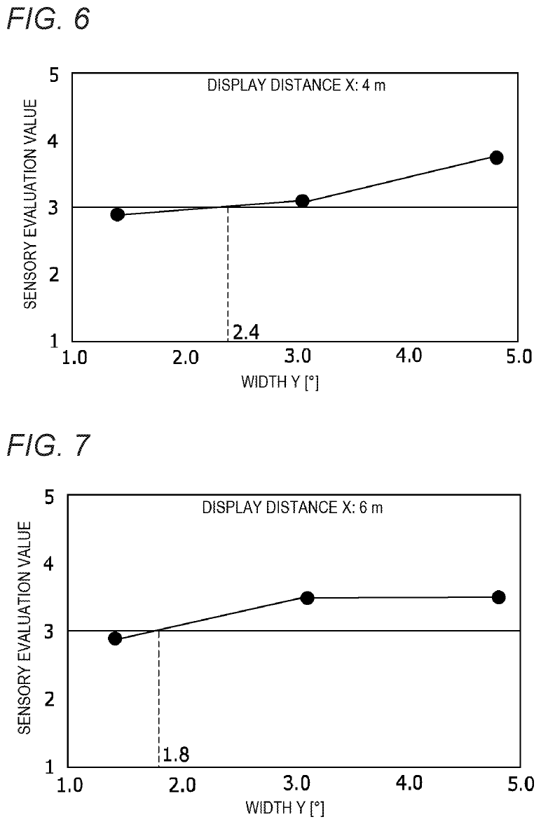

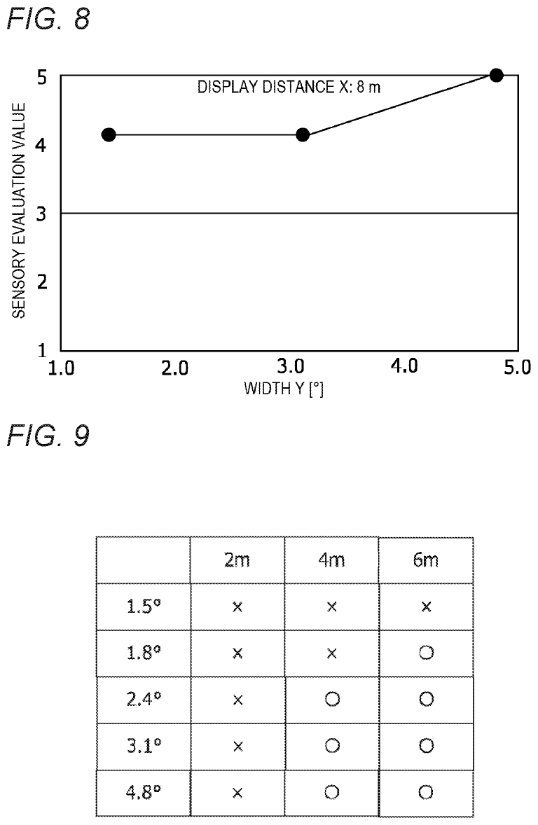

Next, an emission range of visible information emitted by the indicator 20 will be described. The emission range is generally defined by the display distance X described above and a horizontal width Y [°] (a range of a display angle viewed from the gaze point of the driver M) at which the visible information is emitted. The inventor carried out a sensory test for examining whether a viewer who has seen visible information feels annoyed or uncomfortable with the visible information by setting the horizontal width Y at a generally set display distance X=2 m to 8 m. FIGS. 5 to 8 show relationships between a horizontal width of visible information and a sensory evaluation value related to an appearance of the visible information at specific display distances in a sensory test. The display distance in each graph is 2 m in FIG. 5, 4 m in FIG. 6, 6 m in FIG. 7, and 8 m in FIG. 8. The horizontal width Y was set at values of 1.5°, 3.1°, and 4.8° within a generally set range.

Evaluation of test results was performed using five-grade sensory evaluation values (1, 2, 3, 4, 5). The sensory evaluation value 1 refers to evaluation that the visible information becomes a double image and the appearance is fairly annoying, and the sensory evaluation value 5 refers to evaluation that the visible information does not become a double image and is almost not annoying. The sensory evaluation value 3 refers to evaluation between the sensory evaluation value 1 and the sensory evaluation value 5, by which annoyance is within an allowable range (passing line).

When the display distance X in FIG. 5 was 2 m, display was annoying at any horizontal width Y, and no allowable result was obtained. When the display distance X in FIG. 6 was 4 m, no allowable result was obtained at the horizontal width Y=1.5°, and an allowable result was obtained at the horizontal width Y=3.1° and 4.8°. It is found that the horizontal width Y=2.4° at which the sensory evaluation value was 3 between the horizontal width Y=3.1° and the horizontal width Y=4.8° is an allowable boundary value.

When the display distance X in FIG. 7 was 6 m, no allowable result was obtained at the horizontal width Y=1.5°, and an allowable result was obtained at the horizontal width Y=3.1° and 4.8°. It is found that the horizontal width Y=1.8° at which the sensory evaluation value was 3 between the horizontal width Y=1.5° and the horizontal width Y=3.1° is an allowable boundary value. When the display distance X in FIG. 8 was 8 m, an allowable result was obtained at any horizontal width Y.

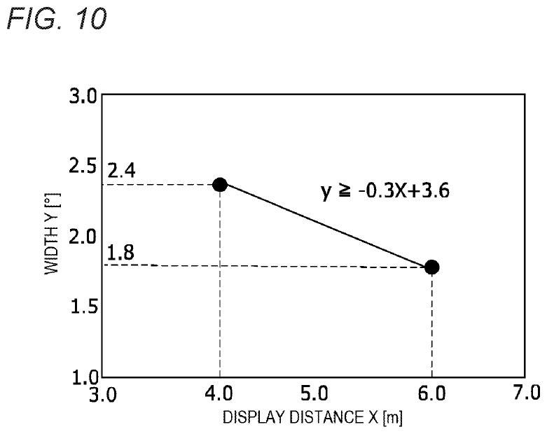

FIG. 9 collectively shows results of the sensory test. A case in which the display distance X is 8 m is omitted. FIG. 10 shows a relationship between a display distance and a horizontal width of visible information for displaying visible information that does not cause annoyance, which is derived from the results of the sensory test. This graph was obtained by summarizing the test results of FIGS. 5 to 8.

From FIG. 5, the setting of the display distance X of 2 m cannot be adopted since no allowable result was obtained. From FIG. 8, the setting of the display distance X of 8 m seems to be no problem. However, extension of the display distance causes an increase in a size of the indicator 20 due to convenience of image generation, and it is not possible to set the display distance X to 8 m from a viewpoint of apparatus size constraints.

Therefore, the inventor studied the allowable range of the horizontal width Y when the display distance X is 4 m or more and 6 m or less. From results of FIGS. 6 and 7, it is found that a formula y=−0.3x+3.6 as shown in FIG. 10 indicates a boundary of whether the horizontal width Y is allowable, and an allowable result is obtained when the horizontal width Y is equal to or larger than this formula. That is, as a result of the sensory test, the vehicle display device 10 and the indicator 20 should emit visible information that satisfies conditions of following formulas (3) and (4).

Y≥−0.3X+3.6 (3)

4≤X≤6 (4)

According to the vehicle display device 10 in the present embodiment, even when visible information is presented in a state in which the driver is looking ahead of the vehicle such as a preceding vehicle, the information can be presented without causing the driver to feel annoyed or uncomfortable due to a double image caused by binocular disparity.

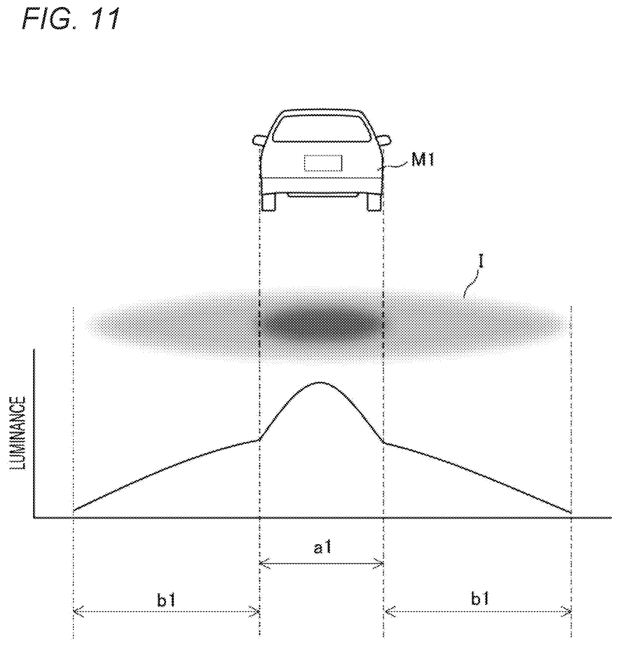

FIG. 11 shows a luminance distribution of visible information when a distance from a preceding vehicle M1 is long. The vehicle display device 10 adjusts the luminance distribution of visible information I according to this graph, and the indicator 20 displays the visible information according to the luminance distribution.

In this example, the indicator 20 displays the visible information I with high luminance in a central portion a1, and the luminance decreases in a peripheral portion b1 toward an outer edge portion. Accordingly, the luminance decreases toward the outer edge portion of the visible information I, and discomfort of a double image can be further alleviated.

Due to such a change in the luminance information, the indicator 20 displays the visible information I with the outer edge portion blurred. Accordingly, a change of the outer edge portion is gentle, and the discomfort of a double image can be further alleviated.

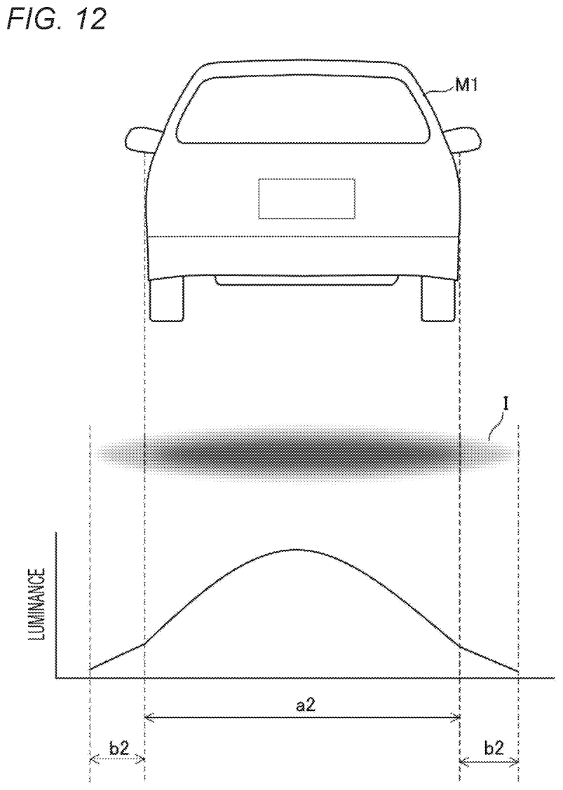

FIG. 12 shows the luminance distribution of the visible information I when the distance from the preceding vehicle M1 is short. The vehicle display device 10 adjusts the luminance distribution of the visible information I according to this graph, and the indicator 20 displays the visible information according to the luminance distribution.

FIG. 12 shows that a range of a central portion a2 where the visible information I has high luminance is larger and a range of a peripheral portion b2 where the visible information I has low luminance is smaller as compared with a case where the distance from the preceding vehicle M1 is long as in FIG. 11. As the preceding vehicle M1 becomes closer, the gaze point of the driver is closer, and a problem of a double image is alleviated, and thus appropriate luminance can be set according to the distance to the preceding vehicle M1.

### Second Embodiment

It is known that annoyance and discomfort can be alleviated by adding movement to visible information. Therefore, the inventor carried out a second sensory test in which movement is added to visible information to examine how annoyance or discomfort with the visible information of a viewer who has seen the visible information changes. FIG. 13 shows a relationship between movement of visible information and a sensory evaluation value related to an appearance of the visible information in the second sensory test regarding visible information displayed by the vehicle display device 10 according to a second embodiment.

From FIG. 13, it is confirmed that annoyance due to a double image can be alleviated by adding movement to the visible information.

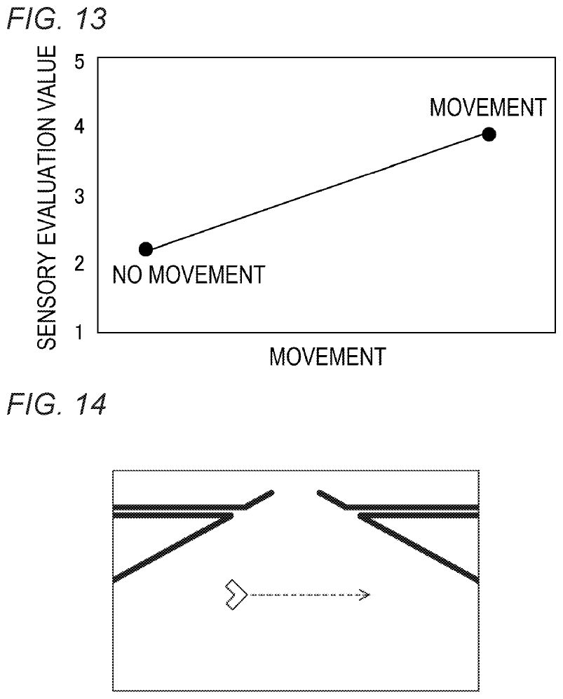

FIG. 14 is a schematic diagram showing movement of visible information displayed by the vehicle display device 10 according to the second embodiment. The visible information in FIG. 14 is an arrow indicating a specific direction. As in this example, addition of movement is a technique suitable for display for indicating a specific direction or guiding a vehicle (route guidance or the like).

When the visible information is a single movement, the driver may not notice the movement, and thus it is desirable to repeatedly present the visible information a plurality of times. In this case, the driver may feel annoyed, has a sense of danger, or the like when a repetition frequency is high, and thus it is desirable to display the visible information with a repetition frequency of about 1 Hz or less.

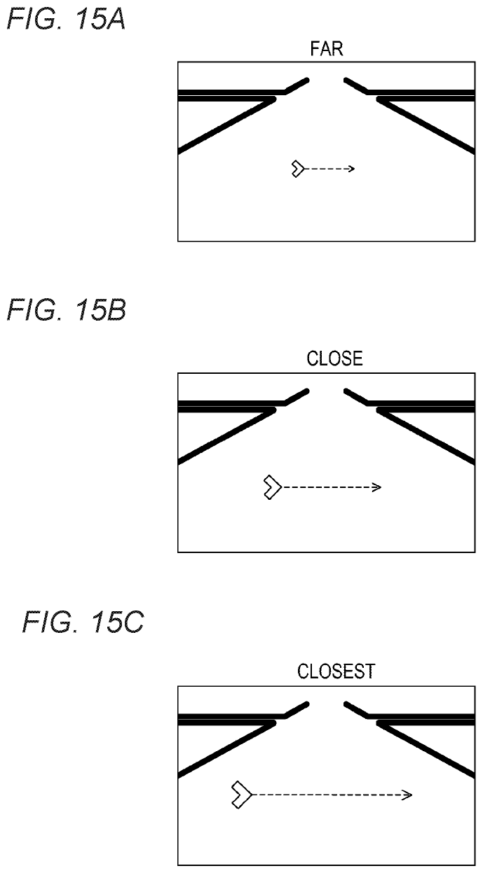

FIGS. 15A to 15C show movement of visible information displayed by the vehicle display device 10 according to the second embodiment at a time of turning right, in which FIG. 15A shows movement at a point far from a right turn point, FIG. 15B shows movement at a point close to the right turn point, and FIG. 15C shows movement at a point closest to the right turn point. For example, when the driver is notified of the right or left turn point and an arrow is repeatedly displayed, it may be difficult for the driver to determine a timing to turn. Therefore, as shown in FIGS. 15A to 15C, it is effective to change a display mode of the visible information as the vehicle approaches a turn point (the right turn point in this example).

In this example, as the vehicle approaches the right turn point, a flowing distance of a rightward arrow, which is the visible information, gradually increases, and a display size also gradually increases. The change of the display mode is not particularly limited, and may be a change from hollow display to solid display. The number of flowing arrows may be changed. For example, the number of arrows displayed is increased such that one arrow in first display, two arrows in second display, and three arrows in third display. Further, the visible information may be displayed while varying at least one of the size, color, movement speed, and period of the visible information in accordance with the distance between the vehicle and the target location.

The movement of the visible information is not limited to a horizontal direction as in FIGS. 14 to 15C, and movement in any direction is allowed as long as the display distance falls within the range.

### Third Embodiment

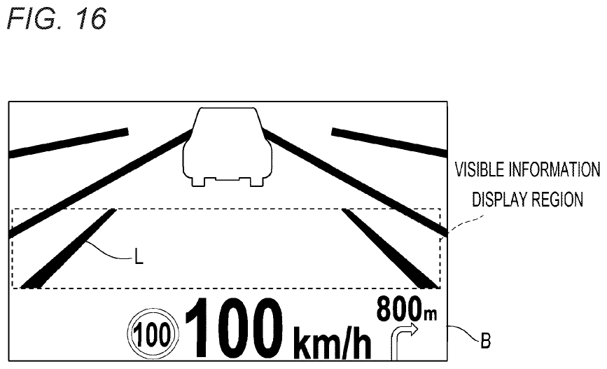

FIG. 16 is a schematic diagram of visible information displayed by the vehicle display device 10 according to a third embodiment. In the present embodiment, the visible information is a lane L displayed corresponding to a lane detected by, for example, a lane keeping assist system (LKA) instead of the spot A by ACC in the first embodiment. Contents of the visible information are not particularly limited.

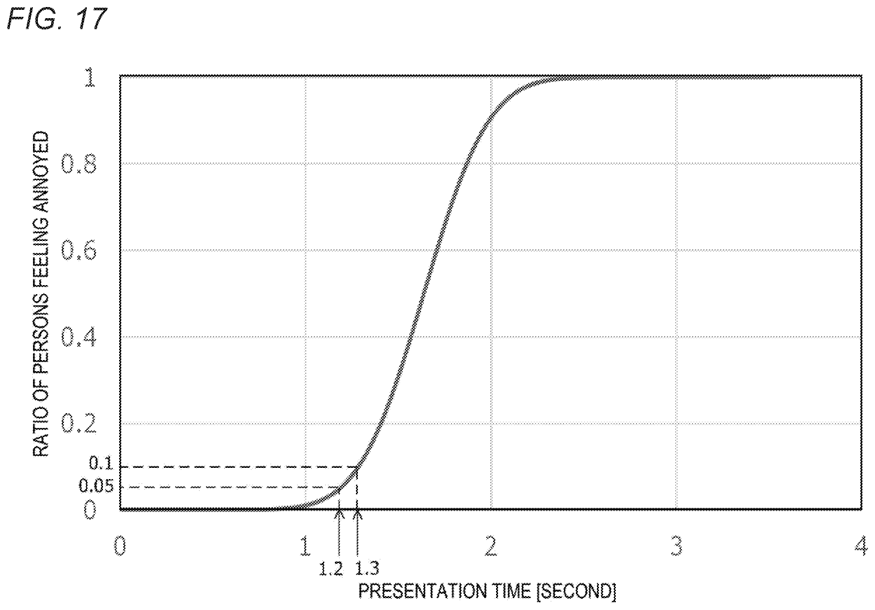

The inventor noticed that, a viewer is likely to feel annoyed by a double image when visible information is presented for a long time, and examined presentation time of the visible information and a ratio of persons feeling annoyed. FIG. 17 shows a relationship between presentation time of visible information and a ratio of persons feeling annoyed with a double image obtained as a result of examination.

From this graph, it is derived that when the presentation time of visible information is 1.3 seconds or less, the number of persons feeling annoyed by a double image is 10% or less, and when the presentation time of visible information is 1.2 seconds or less, the number of person feeling annoyed is 5% or less.

Therefore, by setting the presentation time of visible information to 1.3 seconds or less, discomfort with the double image for most drivers can be alleviated. Further, by setting the time to 1.2 seconds or less, the discomfort with the double image for most drivers can be further alleviated, which is more preferable.

The visible information on the presentation time may be blinking display of the visible information or animation in which display position or display content is switched within the presentation time.

Contents of the first to third embodiments can be implemented individually or in combination.

Although various embodiments are described above with reference to the drawings, it goes without saying that the present disclosure is not limited to these embodiments. It is apparent that those skilled in the art can come up with various modifications or corrections within the scope of the claims, and it is understood that the modifications or corrections naturally fall within the technical scope of the present disclosure. In addition, components described in the above embodiments may be combined freely without departing from the spirit of the disclosure.

Here, features of the embodiments of the vehicle display device according to the present disclosure described above are briefly summarized and listed in following [1] to [3].
[1] A vehicle display device (vehicle display device 10) to be installed in a vehicle (vehicle V) and present visible information emitted from an indicator (indicator 20) to a driver by reflecting the visible information on a windshield, in which
   the indicator emits the visible information such that the visible information to be emitted satisfies formulas (1) and (2) in which a display distance is X [m] and a horizontal width of the visible information is Y [°].

Y≥−0.3X+3.6 (1)

4≤X≤6 (2)

According to the vehicle display device with a configuration of [1], even when visible information is presented in a state in which the driver is looking ahead of the vehicle such as a preceding vehicle, the information can be presented without causing the driver to feel annoyed or uncomfortable due to a double image caused by binocular disparity.
[2] The vehicle display device according to [1], in which
   the indicator displays the visible information while blurring an outer edge portion thereof.

According to the vehicle display device with a configuration of [2], a change of the outer edge portion is gentle, and the discomfort of a double image can be further alleviated.
[3] The vehicle display device according to [1], in which
   the indicator displays the visible information with luminance thereof decreasing toward an outer edge portion.

According to the vehicle display device with a configuration of [3], the luminance decreases toward the outer edge portion, and the discomfort of a double image can be further alleviated.

What is claimed is:

1. A vehicle display device to be installed in a vehicle and present visible information emitted from an indicator to a driver by reflecting the visible information on a windshield, wherein
the indicator emits the visible information such that the visible information to be emitted satisfies formulas (1) and (2) in which a display distance is X [m] and a horizontal width of the visible information is Y [°];
Y≥−0.3X+3.6 (1):
4≤X≤6 (2).

2. The vehicle display device according to claim 1, wherein
the indicator displays the visible information while blurring an outer edge portion thereof.

3. The vehicle display device according to claim 1, wherein
the indicator displays the visible information while decreasing luminance thereof toward an outer edge portion.
